(19) United States
(12) Patent Application Publication
(10) Pub. No.: US 2005/0114774 A1
(43) Pub. Date: May 26, 2005

(54) User controllable computer presentation of interfaces and information selectively provided via a network

(76) Inventor: Ronald P. Berryman, Atlanta, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/933,616

(22) Filed: Sep. 3, 2004

Related U.S. Application Data
(63) Continuation of application No. PCT/US03/06949, filed on Mar. 6, 2003.
(60) Provisional application No. 60/362,147, filed on Mar. 6, 2002.

(51) Int. Cl. G06F 3/00

(52) U.S. Cl. 715/700

(57) ABSTRACT

A system and method for user controllable presentation of content on a user device having an interactive GUI and configured for network interaction with a living content system is provided. The living application system has a set of applications and configuration files. A shell application is run on the client device and is configured to execute one or more applications downloaded to the shell application. Content is provided either directly to the user device from content sources or via the living application system. A GUI management module is configured to apply user preferences to downloaded applications to generate graphical displays on the user device, wherein said graphical displays are real-time displays that can be superimposed over existing windows in a frame having variable opacity, size, continuity, shape and placement.

### PRIORITY CLAIM

This application is a continuation of PCT Patent Application PCT/US03/06949 filed Mar. 6, 2003, entitled “User Controllable Computer Presentation Of Interfaces And Information Selectively Provided Via A Network”, which claims the benefit of priority of U.S. provisional patent application Ser. No. 60/362,147, filed Mar. 6, 2002, entitled “Internet-Based Apparatus and Method For Displaying Information”, the entirety of both of which is hereby incorporated herein by reference.

### STATEMENT OF GOVERNMENT INTEREST

The U.S. Government has no interest in or to the present invention.

### FIELD OF THE INVENTION

The present invention relates to computer devices configured for network connectivity. More particularly, the present invention relates to systems and methods for delivering content to such computer devices via such networks, whether they be wired, wireless, or some combination thereof.

### BACKGROUND

Traditional use of the Internet involves a browser application running on the user's desktop computer. Browsers are reactive applications, responding to user input by searching for and returning that information. Being reactive they are poor solutions for the gathering and display of timely data. Browsers confine information in a window and require that the user both run the browser and be connected to a specific server to receive information.

Emerging uses of the Internet allow information to be “pushed to” hand-held devices or allow the device to “pull from” the Internet. These devices often use proprietary display applications that connect to proprietary servers. This model results in very few sources of information that can be displayed on the device. Alternatively, some devices have an Internet browser. Because the device itself has a very small display and the vast majority of Internet sites are designed for large monitors, the number of sites that can display properly on a hand-held device is limited.

To date, typical applications rely primarily on browsers to display information received over Web-based, or Web-like, networks. There are no applications designed specifically for the display of data from one or more sources, that also allows users to operate the same interfaces on their desktop PC as they would on their hand-held device. Using prior art systems, information does not follow the user, rather a reaction or interface from an application is forced on the user.

### SUMMARY OF THE INVENTION

A network-based (e.g., Web) system provides logic and information for display to an end user device in the form of graphics, animation, images, text, or video feeds, programs, events, promotions or combinations thereof, which may also be referred to as “content”, without the need for a Web browser. The information may be displayed anywhere on the end-user's display, may take on any shape or size of outline, and may be displayed at any level of transparency or opacity. A multi-part dynamic graphical display or image may be split into sub-displays so that information is displayed in the four corners of a user's display screen, for example. The graphical display may be presented “over” another application that the end-user is running, e.g., a local Windows application such as MS Word. The graphical display may be interactive, including user selectable mechanisms for tailoring the graphical image to include more or less information, different opacity, or different screen location, as examples. Additionally, the users activities may be tracked in real-time and metrics generated and provided to content providers, marketers, or others.

The network-based application and content service provider downloads a client-side application (or “shell application”), including display functionality (or a graphics module), to the end-user's device (which may be a wired or wireless desktop, portable, or hand-held device, as examples). Selected applications and configurations files that can operate within the context of the shell application are downloaded to the user's device. User preferences, if any, may also be downloaded. These downloaded applications are referred to as “living” applications, due to the dynamic real-time nature of logic and information provided in accordance with an embodiment of the present invention. The applications and content may be events, programs, promotions and/or real-time status information, such as news, sports scores and highlights, weather information, and financial markets information.

In some implementations, a network-based application and content service system gathers and formats information from one or more sources and provides the information to registered users according to their requests. In other implementations, the application and content service system provides the living applications to the user device, and the living applications connect directly to content sources. In either case, metrics tracking additional functionality may also be provided to track user information to determine the level of interest in a particular event or promotion. This tracking information may be coordinated with a user's registration information to provide analysis (real-time or off-line) of event viewership or demographics, for example.

The shell application enables living applications to provide dynamic, animated, floating, infotainment that allows users to monitor in real-time compelling occurrences, such as sporting events, from an Internet connected device, such as a personal computer, cell phone or PDA, as examples. Information providers can, through a network server, provide real-time information to everyone running a selected living application, as well as modify or update the animations, colors, advertisements, and other graphics being presented at any time. Coupled with the user-information metrics tracking application, the system may also provide information providers or their sponsors with the ability to real-time monitor the behavior of users running the selected living applications.

### BRIEF DESCRIPTION OF THE DRAWINGS

The drawing figures depict preferred embodiments by way of example, not by way of limitations. In the figures, like reference numerals refer to the same or similar elements.

FIG. 1 is a top-level block diagram of a network-based system for providing real-time applications and content to user devices, in accordance with an embodiment of the present invention.

FIG. 2 is a flow diagram of a method that may be employed with the system for FIG. 1.

FIG. 3 is a block diagram demonstrating content presentation using the system of FIG. 1.

FIGS. 4-7 are screen shots showing graphic displays provided using the system of FIG. 1.

FIGS. 8A, 8B, and 9 show an embodiment of the present invention wherein a user device receives content directly from content provider sources.

### DETAILED DESCRIPTION

In accordance with an embodiment of the present invention, a network-based (e.g., Web) system provides logic and information for display to an end user device in the form of graphics, animation, images, text, or video feeds, programs, events, promotions or combinations thereof, which may also be referred to as “content”, without the need for a Web browser. The information may be displayed anywhere on the end-user's display, may take on any shape or size of outline, and may be displayed at any level of transparency or opacity. A multi-part dynamic graphic display or image may be split into sub-displays so that information is displayed in the four corners of a user's display screen, for example. The graphic display may be presented “over” another application that the end-user is running, e.g., a local Windows application such as MS Word. The graphical display may be interactive, including user selectable mechanisms for tailoring the graphical image to include more or less information, different opacity, or different screen location, as examples. Additionally, the users activities may be tracked in real-time and metrics generated and provided to content providers, marketers, or others.

In order to receive the network-based display service, in the preferred form, a user registers with a network-based application and content service provider that may gather information of various types (e.g., text, graphics, animation, video, real-time, static, etc.) from various sources, i.e., data or content sources. During an optional registration process, the end-user may be prompted to enter demographic and psychographic information and allowed to “opt in” to the tracking of his activities related to the displayed network-based information. After registering (if required), the network-based application and content service provider downloads a client-side application (or “shell application”), including display functionality (or a graphics module), to the end-user's device (which may be a wired or wireless desktop, portable, or hand-held device, as examples).

Selected applications that can operate within the context of the application shell are downloaded to the user's device, preferably along with a set of user preferences gathered at registration (optionally required). These downloaded applications are referred to as “living” applications, due to the dynamic real-time nature of logic and information provided in accordance with an embodiment of the present invention. The living applications and content may be events, programs, promotions and/or real-time status information, such as news, sports scores and highlights, weather information, and financial markets information.

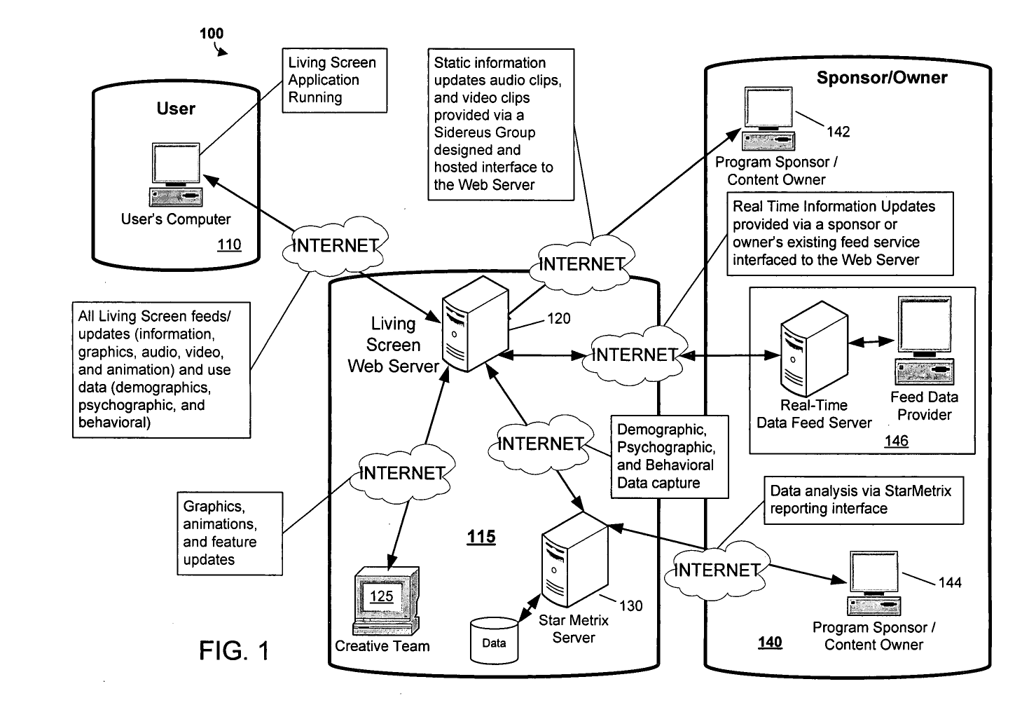

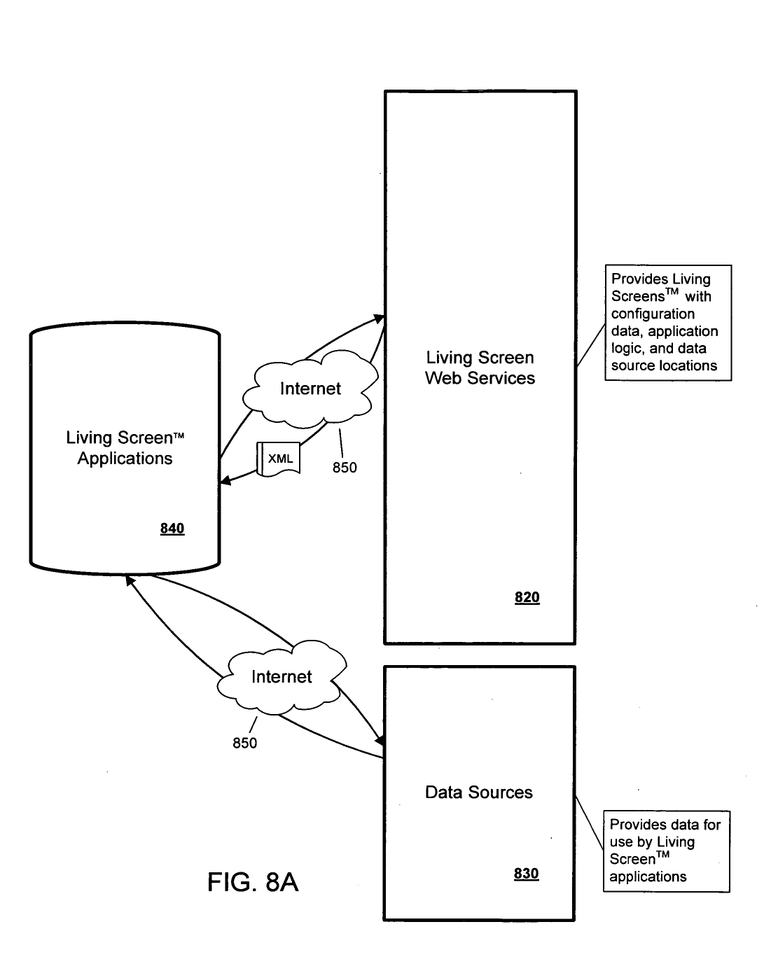

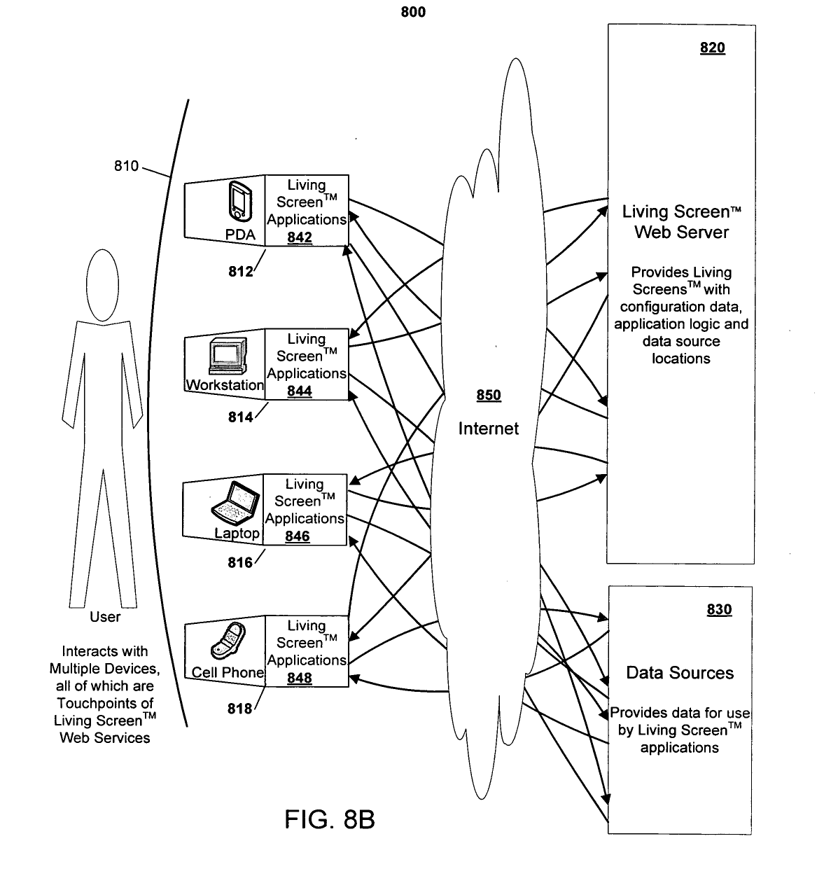

In one embodiment, a network-based application and content service system gathers and formats information from one or more sources and provides the information to registered users according to their requests (see FIG. 1). In another embodiment, the application and content service system provides the living applications to the user device, and the living applications connect directly to content sources (see FIG. 8A and FIG. 8B). In either case, additional functionality may also be provided to track user information to determine the level of interest in a particular event or promotion. This tracking information may be coordinated with a user's registration information to provide analysis (real-time or off-line) of event viewership or demographics, for example.

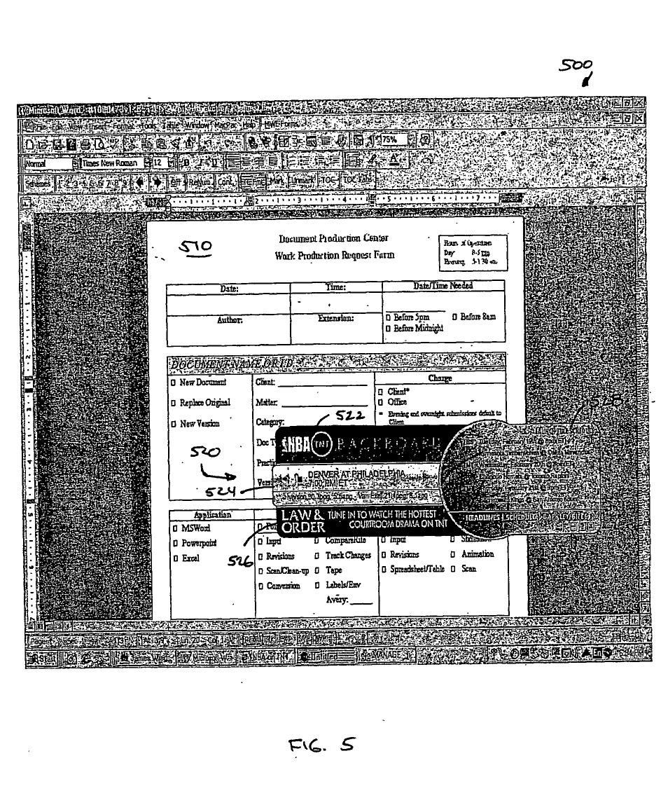

FIG. 1 provides a top-level functional overview of an Internet or Web-based information display system 100 in accordance with an embodiment of the present invention. A user employs an information display device, such as a desktop system 110, to execute applications and display associated information gathered and formatted by a network-based application and content service system 115 dedicated to assembling information of interest to a subscribing/registered end-user. The user device 110 receives a client side shell application that enables living applications to run and provide dynamic, animated and interactive graphic displays, images, or windows. The shell application allows users to monitor in real-time compelling occurrences, such as sporting events, from an Internet connected device, such as a personal computer, cell phone or PDA, as examples. The information may be displayed simultaneously with other applications the user device 110 may be running, e.g., see FIG. 5.

In the embodiment of FIG. 1, although illustrated as a part of a larger network-based application and content service system 115, a living application system 120 could be a stand-alone system or service, as shown in FIG. 8A. In the preferred form, the living application system 120 downloads certain living applications to the user device 110, which are executed in the shell application hosted on device 110. When such applications are “active” (or running) the user device 110 receives data from content providers or data sources, or the owners or sponsors 140 thereof. The content, as discussed above, may include real-time and static data, events, programs, promotions, and updates thereto. As shown, program sponsor/content owner 142, program sponsor/content owner 144, and real-time data feed server and feed data provider 146 provide such content to user device 110, via living application system 120. In other embodiments, as is shown in FIG. 8A, the content need not pass through living application system 120, but a direct connection between the user device and content providers may be provided. Or, a combination of these approaches may be used. While in FIG. 1 the Internet is shown as the only type of network used, those skilled in the art will appreciate that any of a variety of wired and/or wireless networks could alternatively or additionally be used. With a wireless network, those skilled in the art will appreciate that the network may include wireless network gateways (WAGs).

The living application system 120 supports and enables real-time data feeds, providing users with a compelling experience and encouraging users to keep the living application graphics always visible. Information providers may promote events by “tying into” existing coverage or news feeds, for example. Owners of a living application or owners of living application system 120 may provide such promotions. Information providers may employ, through living application system 120, real-time feed override interfaces and static information update interfaces and may thereby update static information, such as event schedules or any text-based information, or replace a real-time feed with a text message. Graphics, animations and feature updates may be provided via a creative (e.g., marketing) system 125, linked to system 120.

The network-based application and content system 115 may also include a metrics system 130 that stores user demographic and psychographic information and monitors end-users' interactions with the living application system 120, or with the living applications and associated content. The metrics system 130 is capable of providing raw data and analysis of such interactions to a sponsor/owner systems 140 that provides content of various forms to end user devices or systems (e.g., desktop system 110), such as via the living application system 120. In FIG. 1, metrics system 130 is shown providing metrics data to program sponsor/content owner 144. The metrics data may be real-time data gathered from a single or multiple users executing or interacting with a living application of, or otherwise receiving content of interest to, program sponsor/content owner 144.

Real-time event triggering and data collection, analysis and reporting are accomplished via metrics system 130, which provides information providers with a powerful data tool set. Information providers have the ability to real-time monitor demographic, behavioral and psychographic characteristics of users running the living applications, as well as other on-line events provided via the living application system 120. The metrics system 130 also supports polling and other forms of information gathering and reporting in real-time.

Behavioral information captured in real-time during a promotion running in a living application and demographic/psychographic information collected during the registration process are stored in a relational database of metrics system 130. Information providers may use a standard graphical user interface to access real-time, daily, weekly, monthly, or program-to-date reports from any network connected device. In addition, events, such as instant rewards and program optimization adjustments can be configured as part of the metrics system 130 implementation. Results of data analysis can automatically stimulate changes in the graphics, data, animations, audio or video that a user sees.

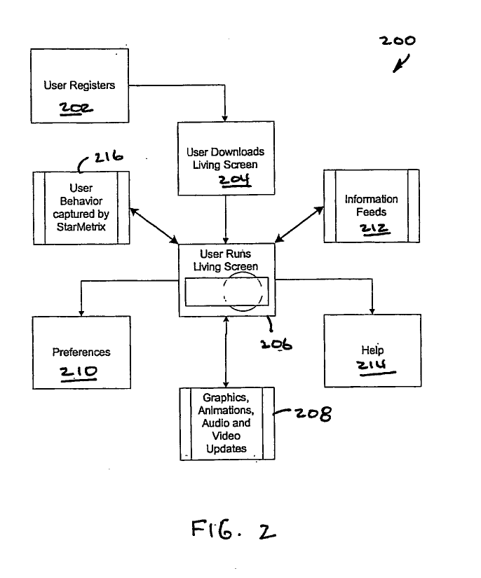

FIG. 2 provides a flow diagram 200 that illustrates, in general terms, the interaction of a user with an illustrative embodiment of an application and content system 120. A user registers, in step 202, with the application and content service system 115, providing whatever information that the information provider wishes to capture for a given living application to be downloaded, or that may otherwise be provided by the operator of the living application system 120. The user then downloads and installs the shell application 204. In step 206, the user runs the shell application, to facilitate the download of living applications from the application and content service system 115. Living applications operating within the context of the shell application may present an animated display to the user, which is preferably tailored to the theme of the living application. The living application may display various types of graphics, which are often unlike “windows”, in a typical sense. The graphic display, which may include dynamically changing and static information, assumes a size and shape dictated largely, at lease initially, by the living application system 120, based on information provider preferences, in step 210, and, optionally, user preferences.

Once living applications are running in the shell application on the user device 110, news, scores, and other real-time information, depending on the living application, are then retrieved from appropriate data sources, in step 212. The information is updated to provide real-time information on any event that an information provider covers. Users have the ability to set preferences, used in step 210, and to have access to a help page, in step 214.

In one embodiment of the present invention, user behavioral data, such as how often the shell application is run, is captured to a data base of the metrics system 130, for program tracking purposes, in step 216. This tracking provides information providers with the ability to real-time monitor on-line campaign success.

The shell application can be configured to reside in an end-user's system tray of the Windows environment, as an example. The shell application could run at Windows startup, with an icon visible in the lower right corner of the Windows Explorer bar, along with the other system tray icons (e.g., power management, security, sound). A system tray presence allows the living application system 120 provider to include features such as:

1) Sleep and Wake-up—Triggering events, such as a new animation, new information, or a graphical change to the interface (new advertisement), would cause the shell application to pop open.

2) Reminders—At shutdown or at the time selected or chosen by the user, a reminder message can be displayed via the application shell. For example, the animation capabilities of some embodiments of the present invention provide information providers with a powerful means of branding. Animations can be used at startup, shutdown, and any event in between.

A graphic display area is provided on the user device 110 by the living application, and can take on any shape, and multiple variations can be made available to users. Since every feature of the a living application's graphical interface is able to be updated at any time during an event, the living application system 120 has the ability to change or add additional shapes to enhance the user experience.

In accordance with an embodiment of the present invention, the graphical display provided in the user's device 110 is enabled to take full advantage of features such as:

1) Clipping, which allows the graphical display to have any shape (not just rectangular) and to move around on the screen. Most applications will take up the entire screen when maximized. Clipping permits the application shell and living applications to make full use of the screen without running as a full-screen application. For example, if an information provider wanted a living application to startup with a ball bouncing around the screen and then morphing into a scoreboard, the living application system 120 would design a round window, put a ball animation in that window, and move the window around the screen to simulate bouncing. The user would still be able to view and interact with any other applications or icons visible on the screen.

2) Maximization and Minimization of living applications is provided; the living application can have one or many different viewable states. For example, a living application graphical display designed for an information provider to promote a sporting event may have several different states: a) large scoreboard showing up-to-date scores, advertisements, and a television schedule; b) toolbar showing a running list of scores or news bytes with icons to change or freeze viewed information; c) triangle window displaying a running list of scores; and d) icon that flashes when news or other information is available;

3) Non-continuous Windows can be made to display information, animations, ads, etc. in several spaces at once. These spaces can reside anywhere on the screen without requiring the commitment of the entire screen.

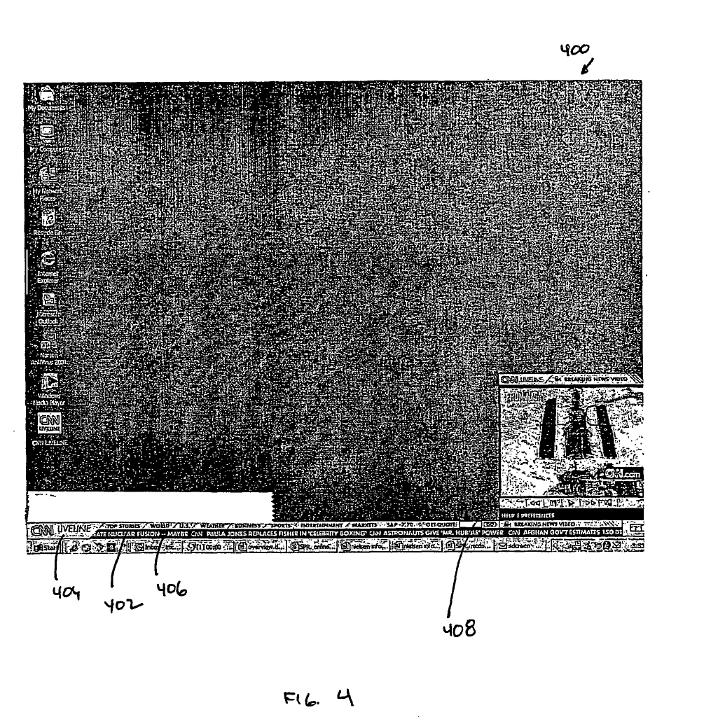

4) Docking is a feature of living applications, wherein a graphical display can be made to dock to the top or bottom of a Windows Desktop, as examples. For living applications that include a toolbar shaped display (see FIG. 4), this is a very useful feature. The user would drag the living application icon to the top or bottom of a user device screen, the living application icon would assume a toolbar shape, and any other toolbars or icons would be rearranged automatically to accommodate the living application toolbar.

The graphical displays of living applications can be partially transparent. The transparency value of the graphics window can range from 0% (opaque) to 100% (completely transparent), depending on the living application. With a mid-range transparency value, users would be able to view whatever other applications, such as a spreadsheet, that are open “underneath” a living application graphic. Coupled with click-thru technology, users can work in one application full screen while viewing a “floating” or “holographic” living application, similar to the information sidebars and icons seen on cable television news and sports channels.

Living applications can include instant messaging or chat room capabilities. These applications can also include reminder messages. These messages can be displayed at a set time, or at Windows shutdown. Information providers or users could have the ability to create or select from a set of reminders, such as the time and network carrying a sporting event.

Living applications can play audio or video files within the graphic display provided for the application, which is enabled by the shell application. For example, a television shaped graphic display with channel buttons or VCR controls can be designed to allow users to interact with video clips, without using the standard Windows Media window. Living applications may play locally stored Windows Media Player compatible audio and video files, download and play new audio and video clips, or support streaming of media files.

An end-user may run multiple living applications (and graphics) simultaneously. Information providers with multiple living applications promotions are able to run them simultaneously and users are not required to choose among the applications. A living application system 120, shell application, or the applications themselves may employ interactivity between living applications to permit the sharing of data among display area, to prevent display areas from inadvertently overlapping, or to prevent two audio feeds from inadvertently operating simultaneously, as examples.

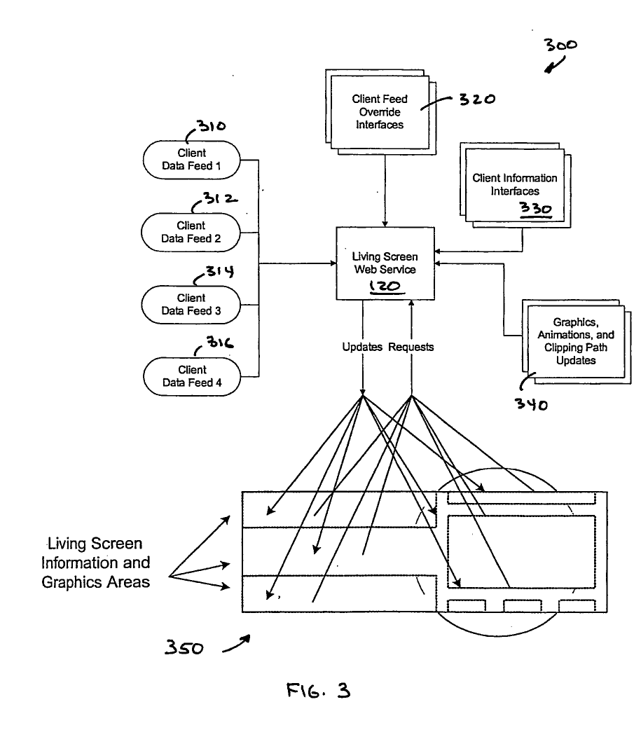

Block diagram 300 of FIG. 3 provides an overview of interactions between an illustrative embodiment of a living application system 120 with various information feeds or content sources and an illustrative display area. Various client feeds 310, 312, 314, and 316 are fed to and formatted by the living application system 120. Client feed override interfaces 320, information interfaces 330, and graphics, animation and clipping path updates 340 are also fed to and formatted by the living application system 120. Any segment of the illustrative graphical display area 350 may be used to display any sort of information: graphic, animation, text, static, etc., at any time.

The elements of a living application's graphic display, such as its shape, advertisements, colors, opacity, presentation options, click-able icons, etc., are able to be updated at any time. This allows content providers the ability to change advertisers mid-campaign, for example, possibly in response to real-time metrics data.

Animation allows information providers to enhance the user experience. For example, the shell application supports Flash animations and supports changing animations at any time. Frequent animation changes can enhance user interest in the content being provided and the living application system 120 may work with information providers to design the most compelling experience possible, which may be largely tailored for or by the user.

All visible elements of the graphical display area 350 may be dynamic, at all times. The living application system 120 works with information providers to tie into existing data feeds and provides information providers with interfaces to update any information that is not feed-based. The living application system 120 consolidates feeds 310, 312, 314, 316 and updates and interacts with the shell application to satisfy information requests.

The screen shot 400 of FIG. 4 illustrates the output of a living application system 120 in accordance with the principles of some embodiments of the present invention, in which a desktop device 110 includes familiar icons 410 (e.g. Internet explorer). A living application selection bar or toolbar 402 allows a user to select from a variety of available living application information displays, such as sports, weather, etc. An information provider may employ a segment of the display area to provide graphical information related to the provider, such as a logo 404. A segment of display may be set aside for scrolling information/selection 406. In this illustrative screen shot 400, a graphical display in the form of a video feed 408 is also displayed in the lower right corner of the desktop 400.

FIG. 5 is a screen shot 500 similar to that of FIG. 4, wherein, as an example, a user may be writing in a word processing application and have a dynamic graphic display rendered over all or part of the document 510. The graphic display, e.g., the application images, data, audio, and/or video, may be dynamically updated in response to real-time feeds. The shell application and living applications may provide non-continuous, variable shape, and/or partially transparent application windows or graphic displays populated by images, data, audio and/or video delivered via the real-time feeds. Additionally, dynamically variable, whole-screen applications may be clipped (as previously described) to expose those areas of an application or desktop of interest to the user.

In screen shot 500, MS Word is running and document 510 is opened and displayed, along with an opaque display 520 provided by the living application system 120. As is apparent from this example, the displayed image 520 may take on any outline. Various segments of the living application graphic display 520 provide different information and may be updated independently. In the illustrative example of FIG. 5, a display segment 522 indicates the type of information and source of information being displayed (i.e., NBA information in this example). A display segment 524 provides real-time updated scores and highlights (e.g., Iverson 30.3 ppg). Another segment 526 provides advertising space, the contents of which may be updated independently of updates to the segment 524. Another segment provides information that, in this example, is much more static than that of the other display segments (e.g., game schedule). A full schedule may be obtained by interaction with the button 528.

The user may switch between interacting with document 510 and the NBA display 520 so that, for example, a mouse click that moves a cursor in the document in one mode selects the size of an NBA playoff graphic display 520 in another mode. Different fields may be defined within a displayed image, some displaying real-time information, such as sports scores, and others displaying static information, such as the name of the content provider or advertisements for commercial sponsors of the content, for example. Video clips and/or streaming video may also be displayed within a segment of the graphic display. A plurality of graphic displays may be employed to render different types of information provided by the same content provider or to display information from different content providers in the various graphic displays. The displayed images may be interactive, so that, for example, one display will not over-write another.

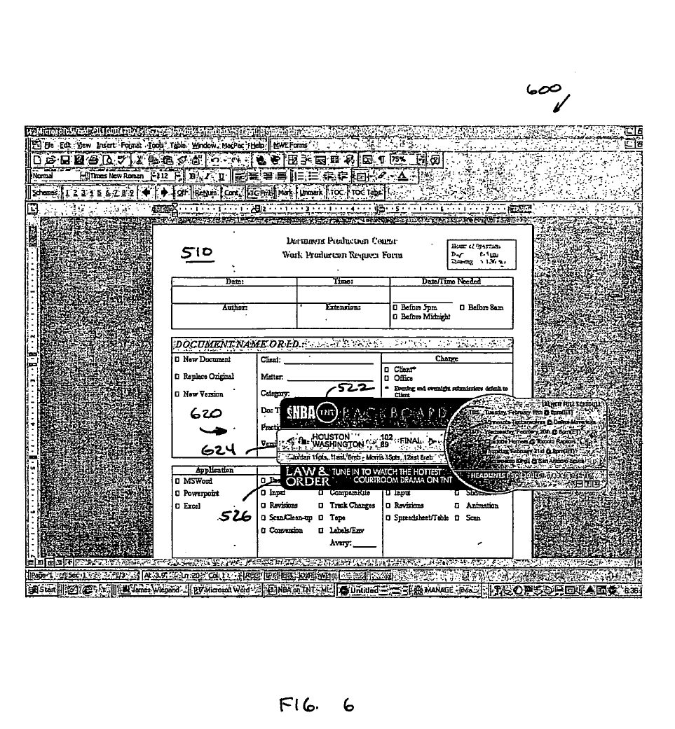

Screen shot 600 of FIG. 6 illustrates a display similar to that of FIG. 5, with information in graphic display 520 of FIG. 5 having been updated in FIG. 6 to form graphic display 620. The information in area 522 and 526 have remained static, while the information in area 624 has been updated.

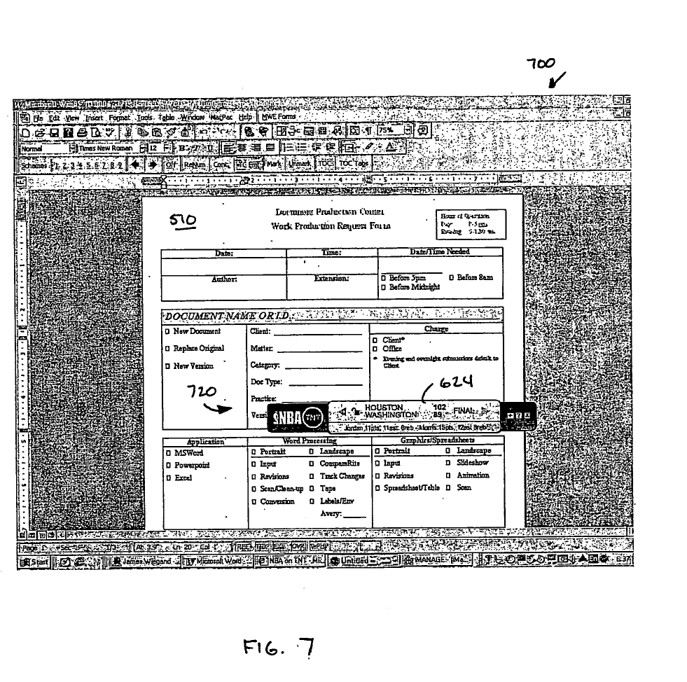

FIG. 7 is a screen shot 700 that illustrates a reduced graphic display 720 having information similar to that provided by the graphic displays 520 of FIGS. 5 and 620 of FIG. 6. In FIG. 7, area 624 has remained unchanged, but the remainder of the graphical display 720 has been reduced.

The block diagram of FIG. 8A is a top-level overview of another embodiment of a network-based information display system 800, in accordance with an embodiment of the present invention. As previously referred to, in this embodiment a user device accesses living application system 820 via a network (e.g., Internet 850) for registration (if required) and the download of living applications 840. Once downloaded, the living applications 840 get content from data sources 830 directly.

In FIG. 8B, one or more user devices 810 may each be configured to facilitate the download of selected applications (e.g., applications 842, 844, 846, and 848) from a network-based living application system 820. The system may include, for example, Web-based server (s) hosting various components or services of the living application system 820. Generally speaking, the living application system 820 may be referred to as a Web services provider having an application distribution management program. In the case of Web-based services, the network is, or includes, the Internet 850. In other embodiments, other types of networks may additionally or alternatively be used, such as WANs, LANs, WAGs, intranets, extranets, VPNs, cellular networks, or any combination thereof. In any of the embodiments, the user devices may be PDA 812, workstation 814, laptop 816, and cell phone 818, or any other type of network enabled device having a graphical user interface. In the preferred form, the living applications 842, 844, 846, and 848 are configured to obtain content, including real-time content, from content providers/data sources 830. In other forms, some or all of the content could come to the living applications via the living application system 820. In still other forms, the living application programs could be configured to obtain applications or content directly from third party sources, that may or may not be included content providers 830.

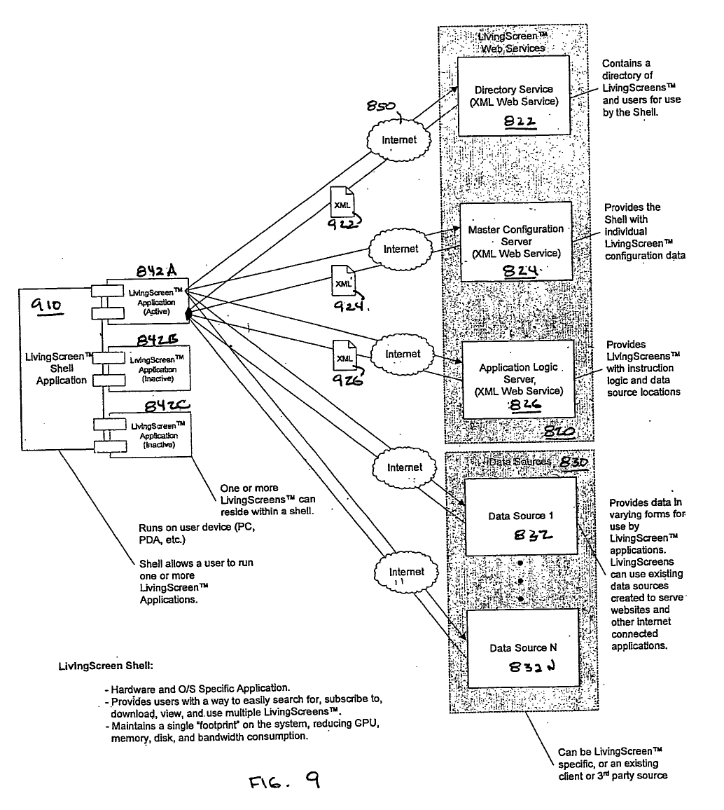

FIG. 9A is a logical overview of an application architecture 900, in accordance with the embodiment of FIG. 8A and FIG. 8B. Each user device 810 includes a shell application 910. The shell application interacts with the living application system 820 to obtain applications, e.g., applications 842A, 842B, and 842C. That is, within the shell application a plurality of living applications may be simultaneously run. In FIG. 9A, only application 842A is “active”; applications 842B and 842C are “inactive”. An inactive application need not be downloaded to the user's device until made active. However, in other embodiments, inactive living applications may be downloaded and sit dormant unless and until activated.

The application source 820 includes, in the preferred embodiment, a directory service 822, a master configuration service 824, and an application logic service 826, which may be run on any combination of servers. Generally, the directory service 822 includes a directory of applications and users. The master configuration service 824 provides the shell application with individual application configuration data. And, the application logic service 826 provides instruction logic and data source locations for use by the living applications. The set of data sources 830, may include any number of data or content sources 832 . . . 832N. Such data may, for example, be any combination of static and dynamic data. As just a few examples, dynamic data may include sports scores, financial markets activity, weather information, or breaking news.

In the preferred form, the directory service 822, master configuration service 824, and application logic service 826 are XML web services. As such, information provided to the shell application 910 is preferably provided in the form of XML documents 922, 924, and 926.

Shell application 910 is preferably a hardware and O/S specific application that provides users with a way to easily search for, subscribe to, download, view and use multiple living applications and associated content. The shell application 910 also preferably maintains a single “footprint” on the user's system, reducing CPU, memory, disk and bandwidth consumption.

With respect to the interaction between the shell application 910 and the directory service 822, the directory service 822 includes a master list of users, available living applications (and related graphical displays), and configuration file locations. The master list changes as applications are added or removed. The shell application 910 sends product (e.g., application) identifiers and requests permissions and configuration information from the directory service 822. The directory service 822 returns a list of available living applications (and related graphical displays) and configuration file locations to the shell application 910, in the form of XML document 922.

With respect to the interaction between the shell application 910 and the master configuration service 824, the master configuration service 824 may contain many configuration files for many different living applications. Using the list of available living applications and the configuration file locations, for a given listed living application the shell application 910 sends living screen identifiers and requests the appropriate configuration file (s) from the master configuration service 824. In response, master configuration service 824 sends master configuration file (s), in the form of XML document 924. The master configuration file includes high level application logic and locations of application specific data sources, which only changes when data sources change.

With respect to the interaction between the shell application 910 and the application logic service 826, the application logic service 826 provides to living applications skins, GUI logic, dynamic reconfiguration logic, and content logic. Skins are basic components of the user interface, such as template and layout information. The GUI logic includes event handlers that provides instructions to the living application on how to respond to specific user interactions. The dynamic reconfiguration logic is logic that keeps the living application current, by facilitating the ability of the living application components to replace themselves dynamically during the course of operation. The content logic controls functionality of specific content used by the living application. That is, the content logic tells the application where to get content, what to do with it, and how to react to user activity.

The data/content sources 830 may contain any of a variety of types of data, as previously discussed. Common types of data include HTML (Web pages), XML, streaming media (e.g., video and audio), ASCII transfers, binary transfers, (e.g., graphics, audio, and video) and binary objects (e.g., application components, data, and instructions). The data/content sources 830 are optional connections from a living application 840, but preferably at least one is provided in each deployment. The data/content sources 830 are located by the living application 140 reading its configuration data file (provided by the application logic service 826 or the master configuration service 824).

While the foregoing has described what are considered to be, the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

1. A method for presentation of information to a user via a user device having an interactive interface and configured for access to a network, the method comprising:
providing a plurality of interface applications which present information to a user, at least one of the interface applications receiving, via the network, content relating to the information; and
providing a shell application to manage the plurality of interface applications, the shell application controlling at least one of the size of, the shape of, the opacity of, the display location on the interactive interface of, and the network access of, the at least one interface application.

2. The method of claim 1 wherein the shell application controls the display location on the interactive interface of the at least one interface application.

3. The method of claim 1 wherein the shell application controls the display location on the interactive interface of a first interface application and the display location on the interactive interface of a second interface application, and causes the display location of the first interface application to be different from the display location of the second interface application.

4. The method of claim 1 wherein the information further comprises at least one of audio, video, images, text, graphics, data and animations.

5. The method of claim 1, wherein the interactive interface of the user device has a display including a system tray, the system tray has icons representing at least one device operation, and the method further comprises the shell application presenting an icon in the system tray.

6. The method of claim 5, and further comprising:
the shell application monitoring for the occurrence of a predetermined event; and
the shell application taking a predetermined action in response to the predetermined event.

7. The method of claim 6 wherein the predetermined event comprises receiving new content, and the predetermined action is the shell application opening to present information to the user via the interactive interface.

8. The method of claim 7 wherein the new content is an advertisement.

9. A method for presentation of information to a user via a user device having an interactive interface and configured for access to a network, the method comprising:
providing a plurality of interface applications which present information to a user;
at least one of the interface applications receiving content, via the network, relating to the information and presenting the information via a plurality of windows; and
providing a shell application to manage the plurality of interface applications.

10. The method of claim 9 wherein the plurality of windows is non-continuous on the interactive interface.

11. The method of claim 9 wherein at least one window of the plurality of windows provides information which is different than the information provided by at least one other window of the plurality of windows.

12. The method of claim 9 wherein at least one window of the plurality of windows has a shape which is different than the shape of at least one other window of the plurality of windows.

13. The method of claim 9 wherein at least one window of the plurality of windows presents at least one of audio, video, images, text, graphics, data and animations, and another window of the plurality of windows presents at least one of audio, video, images, text, graphics, data and animations.

14. The method of claim 9 wherein at least one window of the plurality of windows presents at least one of audio, video, images, text, graphics, data and animations, and another window of the plurality of windows presents a different one of audio, video, images, text, graphics, data and animations.

15. A method for presentation of information to a user via a user device having an interactive interface and configured for access to a network, the method comprising:
providing a plurality of interface applications which present information to a user;
at least one of the interface applications receiving content, via the network, relating to the information, presenting the information via a window, and performing at least one of moving the window around on the interactive interface and changing the shape of the window; and
providing a shell application to manage the plurality of interface applications.

16. The method of claim 15 wherein the at least one interface application moves the window around on the interactive interface while changing the shape of the window.

17. The method of claim 16 wherein the at least one interface application moves the window to a docking bar on the interactive interface and changes the shape of the window to a toolbar.
